(19) United States
(12) Patent Application Publication
(10) Pub. No.: US 2016/0072168 A1
(43) Pub. Date: Mar. 10, 2016

(54) MULTIBAND FILTER

(71) Applicant: Kabushiki Kaisha Toshiba, Minato-ku (JP)

(72) Inventors: Tamio KAWAGUCHI, Kawasaki (JP); Noritsugu SHIOKAWA, Yokohama (JP); Hiroyuki KAYANO, Fujisawa (JP); Kohei NAKAYAMA, Kawasaki (JP); Mutsuki YAMAZAKI, Yokohama (JP)

(73) Assignee: Kabushiki Kaisha Toshiba, Minato-ku (JP)

(21) Appl. No.: 14/794,183

(22) Filed: Jul. 8, 2015

(30) Foreign Application Priority Data
Sep. 8, 2014 (JP) 2014-182375

(51) Int. Cl. H01P 1/203; H01P 7/08; H01B 12/02

(52) U.S. Cl. CPC H01P 1/203; H01P 7/082

(57) ABSTRACT

According to one embodiment, a multiband filter includes a first resonator and a second resonator. The first resonator has a first capacitive component and a first inductive component. A signal of a first frequency is inputted to the first resonator. The second resonator has a second capacitive component and a second inductive component. A signal of a second frequency is inputted to the second resonator. The second frequency is different from the first frequency. A distance between a first capacitive component of the first resonator and a second capacitive component of the second resonator and a distance between a first inductive component of the first resonator and a second inductive component of the second resonator is longer than a shortest distance out of a distance between the first resonator and the second resonator. The capacitive components occur at the capacitance. The inductive components occur at the inductance.

### CROSS-REFERENCE TO RELATED APPLICATIONS

This application is based upon and claims the benefit of priority from Japanese Patent Application No. 2014-182375, filed on Sep. 8, 2014; the entire contents of which are incorporated herein by reference.

### FIELD

Embodiments described herein relate generally to a multiband filter.

### BACKGROUND

In the recent wireless communication, carrier aggregation communication has attracted attention, communicating using a plurality of frequency bands. For correspondence to the communication system, a multiband filter having a plurality of passbands is desired. However, the multiband filter corresponding to the plurality of frequency bands is multiplexed by connecting in parallel a plurality of filters having different frequency bands while reducing coupling between the respective filters, and thus a size of filter has increased.

### BRIEF DESCRIPTION OF THE DRAWINGS

FIG. 1 is a perspective view illustrating a multiband filter according to a first embodiment;

FIG. 2 is an equivalent circuit diagram illustrating the multiband filter according to the first embodiment;

FIG. 3 is a circuit diagram illustrating coupling between resonators in the first embodiment;

FIG. 4 is a pattern diagram illustrating disposition of the resonators in the first embodiment;

FIG. 5 illustrates a graph of a relationship between disposition of the resonators according to the first embodiment and a coupling coefficient k by representing a gap d shown in FIG. 4 on a horizontal axis and representing the coupling coefficient k on a vertical axis;

FIG. 6 is a pattern diagram illustrating a range existing between the two resonators in the first embodiment with the gap d;

FIG. 7 is a pattern diagram illustrating disposition of resonators in a first comparative example;

FIG. 8 illustrates a graph of a relationship between disposition of the resonators and the coupling coefficient k by representing the gap d shown in FIG. 7 on a horizontal axis and representing the coupling coefficient k on a vertical axis;

FIG. 9 is a pattern diagram illustrating disposition of the resonators in a second comparative example;

FIG. 10 illustrates a graph of a relationship between disposition of the resonators and the coupling coefficient k by representing the gap d shown in FIG. 9 on a horizontal axis and representing the coupling coefficient k on a vertical axis;

FIG. 11 is a perspective view illustrating a multiband filter according to a second embodiment;

FIG. 12 is a pattern diagram illustrating disposition of the resonators in the second embodiment;

FIG. 13 is a perspective view illustrating a multiband filter according to a third embodiment;

FIG. 14 is a perspective view illustrating a resonator in the third embodiment;

FIG. 15 is an equivalent diagram illustrating the resonator in the third embodiment;

FIG. 16 is a pattern diagram illustrating disposition of the resonators in the third embodiment;

FIG. 17 is a pattern diagram illustrating disposition of resonators in a first comparative example;

FIG. 18 is a pattern diagram illustrating disposition of resonators in a second comparative example;

FIG. 19 illustrates a graph diagram of frequency characteristics of a multiband filter according to the third embodiment by representing a frequency on a horizontal axis and representing transmission quantity on a vertical axis;

FIG. 20 is a perspective view illustrating a multiband filter according to a fourth embodiment; and

FIG. 21 is a perspective view illustrating a multiband filter according to a variation of the fourth embodiment.

### DETAILED DESCRIPTION

According to one embodiment, a multiband filter includes a first resonator and a second resonator. The first resonator has a first capacitive component and a first inductive component. A signal of a first frequency is inputted to the first resonator. The second resonator has a second capacitive component and a second inductive component. A signal of a second frequency is inputted to the second resonator. The second frequency is different from the first frequency. A distance between a first capacitive component of the first resonator and a second capacitive component of the second resonator and a distance between a first inductive component of the first resonator and a second inductive component of the second resonator is longer than a shortest distance out of a distance between the first resonator and the second resonator. The first capacitive component occurs at the first capacitance. The second capacitive component occurs at the second capacitance. The first inductive component occurs at the first inductance. The second inductive component occurs at the second inductance.

Various embodiments will be described hereinafter with reference to the accompanying drawings.

A first embodiment will be described.

First, the configuration of a multiband filter according to the embodiment will be described.

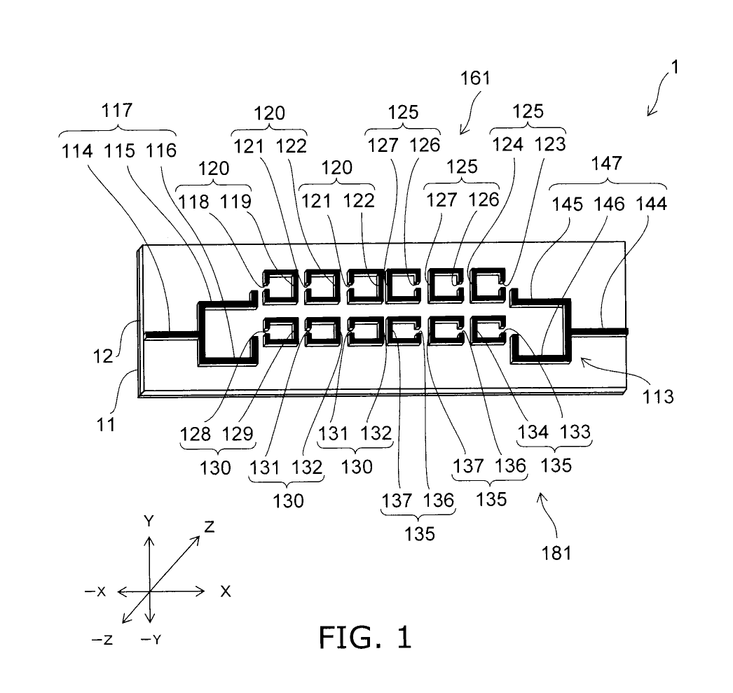

FIG. 1 is a perspective view illustrating a multiband filter according to the embodiment.

As shown in FIG. 1, a dielectric substrate 12 is provided in a multiband filter 1 according to the embodiment. A ground conductor plate 11 is provided on a lower surface of the dielectric substrate 12 and a transmission line conductor unit 113 is provided on an upper surface.

Hereinafter, in the specification, an XYZ orthogonal coordinate system is adopted for convenience of description. That is, in FIG. 1, two directions parallel to a contact plane between the dielectric substrate 12 and the ground conductor plate 11 and mutually orthogonal are taken as “X-direction” and “Y-direction”, respectively. A reverse direction of “X-direction” is taken as “−X-direction”, and a reverse direction of “Y-direction” is taken as “−Y-direction”. An upward direction perpendicular to the contact plane between the dielectric substrate 12 and the ground conductor plate 11 is taken as “Z-direction”, and a reverse direction of “Z-direction” is taken as “−Z-direction”.

The transmission line conductor unit 113 is formed of a division multiplexing unit 117, a first filter unit 161, a second filter unit 181 and a division multiplexing unit 147. The first filter unit 161 is formed of first resonators 120 and first resonators 125. The second filter unit 181 is formed of second resonators 130 and second resonators 135.

An input/output portion 114 of the division multiplexing unit 117 is disposed at an end on the dielectric substrate 12 in the −X-direction, a branch 115 of the division multiplexing unit 117 is disposed near a both ends open portion 118 of the first resonator 120, and a branch 116 of the division multiplexing unit 117 is disposed near a both ends open portion 128 of the second resonator 130. An input/output portion 144 of the division multiplexing unit 147 is disposed at another end on the dielectric substrate 12, a branch 145 of the division multiplexing unit 147 is disposed near a both ends open portion 123 of the first resonator 125, and a branch 146 of the division multiplexing unit 147 is disposed near a both ends open portion 133 of the second resonator 135.

In the division multiplexing unit 117, the input/output portion 114 in an interconnect configuration extends in the X-direction from an end edge of the dielectric substrate 12 in the −X-direction, branches into the branches 115 and 116 at an end of the input/output portion 114 in the X-direction, and the branches 115 and 116 are disposed distantly in the Y-direction. The branch 115 is extracted from one end of the input/output portion 114, is inflected beyond to extend in the X-direction, and is inflected again beyond to extend in the Y-direction and is terminated. The branch 116 is extracted in the −Y-direction from the end of the input/output portion 114 where the branch 115 is extracted, is inflected beyond to extend in the X-direction, and is inflected again beyond to extend in the Y-direction and is terminated. A termination of the branch 115 and a termination of the branch 116 extend in the same direction, however the lengths are different, and the termination of the branch 116 is longer than the termination of the branch 115.

A configuration of the first resonators 120 is frame-shaped being lack of a center of one side, generally C-shaped. The lack portion is the both ends open portion 118, and the portion opposing the both ends open portion 118 is a line center 119. The respective first resonators 120 are disposed so that the both ends open portion 118 faces the −Y-direction, namely, the division multiplexing unit 117 side.

A configuration of the first resonators 125 forms a mirror image of the first resonators 120 about a YZ-plane. A configuration of the division multiplexing unit 147 forms a mirror image of the division multiplexing unit 117 about the YZ-plane.

A configuration of the second resonators 130 is generally C-shaped similar to the first resonators 120. The lack portion is the both ends open portion 128, and the portion opposing the both ends open portion 128 is a line center 129. The line center 129 of the second resonator 130 is shorter than the line center 119 of the first resonator 120. The respective first resonators 130 are disposed so that the both ends open portion 128 faces the division multiplexing unit 117 side. A configuration of the second resonators 135 forms a mirror image of the second resonators 130 about the YZ-plane.

The division multiplexing unit 117 is disposed on the end of the dielectric substrate 12 in the −X-direction. The end of the division multiplexing unit 117 in the −X-direction reaches the end edge of the dielectric substrate 12 in the −Y-direction. On the other hand, the division multiplexing unit 147 is disposed on the end of the dielectric substrate 12 in the Y-direction. The end of the division multiplexing unit 147 reaches an end edge of the dielectric substrate 12 in the X-direction. The first filter unit 161 and the second filter unit 181 are disposed between the division multiplexing unit 117 and the division multiplexing unit 147 in parallel, and mutually isolated in the Y-direction. The second filter unit 181 is disposed in the −Y-direction viewed from the first filter unit 161.

In the first filter unit 161, for example, three first resonators 120 are disposed in a portion in the −X-direction and three first resonators 125 are disposed in a portion in the X-direction. These six first resonators in total 120 and 125 are arranged in a line along the X-direction. On the other hand, in the second filter unit 181, for example, three second resonators 130 are disposed in the portion in the −X-direction and three second resonators 135 are disposed in the portion in the X-direction. These six second resonators in total 130 and 135 are arranged in a line along the X-direction. The division multiplexing unit 117, the division multiplexing unit 147, the first resonators 120, the first resonators 125, the second resonators 130 and the second resonators 135 are mutually isolated.

The first filter unit 161 is a filter for a first passband from a frequency (f_{c1}−df₁/2) to (f_{c1}+df₁/2). A center frequency in the first passband is taken as f_{c1}, and a first bandwidth is taken as df₁.

As described above, the first resonators 120 and the first resonators 125 have a configuration of one inflected microstrip line resonator and have the open end. An electrical length of the microstrip line resonator is a length of an integral multiple of a half of a corresponding wavelength in a range from the frequency (f_{c1}−df₁/2) to (f_{c1}+df₁/2).

The second filter unit 181 is a filter for another second passband from the frequency (f_{c2}−df₂/2) to (f_{c2}+df₂/2) different from the first passband. A center frequency in the second passband is taken as f_{c2}, and a second bandwidth is taken as df₂.

The second resonators 130 and the second resonators 135 have a configuration of one inflected microstrip line resonator similar to the first resonators and have the open end. An electrical length of the microstrip line resonator is a length of an integral multiple of a half of a corresponding wavelength in a range from the frequency (f_{c2}−df₂/2) to (f_{c2}+df₂/2).

Materials of the dielectric substrate 12 may include various suitable materials, for example, such as magnesium oxide, sapphire(Al₂O₃), or lanthanum aluminate or the like. The transmission line conductor unit 113 can be formed of a conductive material. The conductive material may be a material including, for example, a metal such as copper or gold, a superconductor such as niobium or niobium-tin, or a Y-based copper oxide high temperature superconductor. The superconductor is used as the conductive material of the transmission line conductor unit 113, and thereby passing loss of a circuit in a superconducting state can be largely decreased.

For example, a copper oxide high temperature superconducting film having a thickness of about 500 nm and a line width of about 0.4 mm is formed on the dielectric substrate 12 made of magnesium oxide having a thickness of about 0.5 mm and a specific permittivity of about 9.6, and this film may be the microstrip line resonator as well. For forming the Y-based copper oxide high temperature superconducting film, a laser deposition method, a sputtering method or a co-deposition method or the like may be used.

Next, an operation of a multiband filter 1 according to the embodiment will be described.

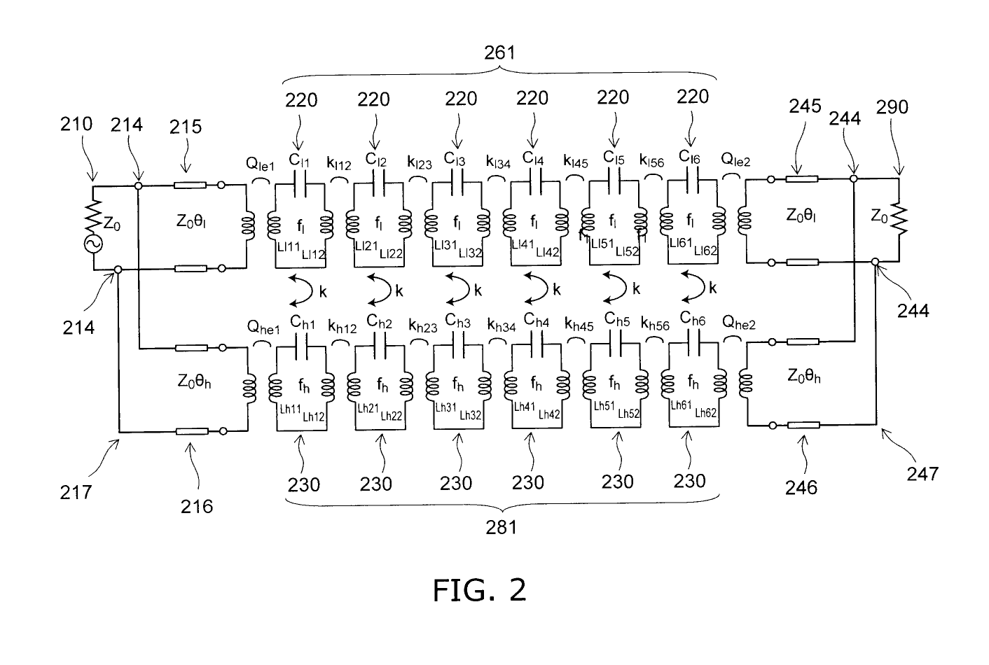

FIG. 2 is an equivalent circuit diagram illustrating the multiband filter according to the embodiment. A first filter unit 261 shown in FIG. 2 corresponds to the first filter unit 161 shown in FIG. 1. A second filter unit 281 shown in FIG. 2 corresponds to the second filter unit 181 shown in FIG. 1. A division multiplexing unit 217 shown in FIG. 2 corresponds to the division multiplexing unit 117 shown in FIG. 1. A division multiplexing unit 247 shown in FIG. 2 corresponds to the division multiplexing unit 147 shown in FIG. 1.

As shown in FIG. 2, the multiband filter 1 according to the embodiment is formed of the first filter unit 261 for the first passband, the second filter unit 281 for the second passband, and the division multiplexing units 217 and 247 dividing and multiplexing signals.

The first filter unit 261 consists of first resonators 220 with the resonant frequency f₁ of the first passband. The first resonator 220 of first-order from the left in FIG. 2 and a branch 215 of the division multiplexing unit 217 are coupled with external Q, Qᵢₑ₁ showing coupling with a signal input line. The first resonator 220 of i-th and the first resonator 220 of j-th from the left in FIG. 2 are coupled with a coupling coefficient kₗᵢⱼ. Where, i and j are set to be integer. The first resonator 220 of first-order from the right in FIG. 2 and a branch 245 of the division multiplexing unit 247 are coupled with external Q, Qᵢₑ₂ showing coupling with a signal input line.

The division multiplexing unit 217 consists of an input/output portion 214 connected to an external circuit 210 having an external load Z₀, the branch 215 coupled with the first filter unit 261, and a branch 216 coupled with the second filter unit 281. The branch 215 has a line length having a phase shifted by θₗ at a wavelength corresponding to the load Z₀ and a resonant frequency fₗ of the first passband. The branch 216 has a line length having a phase shifted by θₕ at a wavelength corresponding to the load Z₀ and a resonant frequency fₕ of the second passband.

The second filter unit 281 consists of second resonators 230 with a resonant frequency fₕ of the second passband. The second resonator 230 of first-order from the left in FIG. 2 and the branch 216 of the division multiplexing unit 217 are coupled with external Q, Qₕₑ₁ showing coupling with a signal input line. The second resonator 230 of i-th and the second resonator 230 of j-th from the left in FIG. 2 are coupled with a coupling coefficient kₕᵢⱼ. The second resonator of first-order from the right in FIG. 2 and a branch 246 of the division multiplexing unit 247 are coupled with external Q, Qₕₑ₂ showing coupling with a signal input line.

The division multiplexing unit 247 consists of an input/output portion 244 connected to an external circuit 290 having an external load Z₀, the branch 245 coupled with the first filter unit 261, and the branch 246 coupled with the second filter unit 281. The branch 245 has a line length having a phase shifted by θₗ at a wavelength corresponding to the load Z₀ and a resonant frequency fₗ of the first passband. The branch 246 has a line length having a phase shifted by θₕ at a wavelength corresponding to the load Z₀ and a resonant frequency fₕ of the second passband.

The first filter unit 261 shown in FIG. 2 corresponds to the first filter unit 161 shown in FIG. 1. The second filter unit 281 shown in FIG. 2 corresponds to the second filter unit 181 shown in FIG. 1. Therefore, the first filter unit 261 and the second filter unit 281 are adjacent similar to the first filter unit 161 and the second filter unit 181 shown in FIG. 1, and thus the first resonator 220 and the second resonator 230 couple with the coupling coefficient k. As a result, isolation is not sufficient outside a band. The coupling coefficient k between these resonators is preferable to be small in order to reduce the coupling between the first resonator 220 and the second resonator 230.

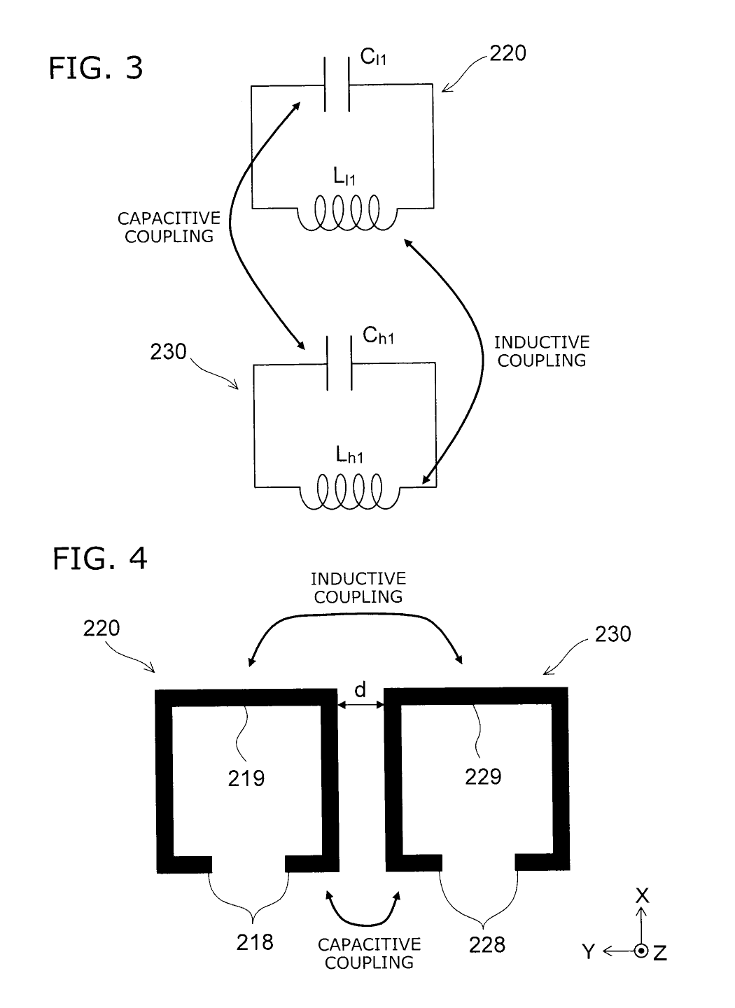

FIG. 3 is a circuit diagram illustrating coupling between resonators in the embodiment.

As shown in FIG. 3, the first resonator 220 can be shown by a capacitive element Cₗ₁ and an inductive element Lₗ₁. The second resonator 230 can be shown by a capacitive element Cₕ₁ and an inductive element Lₕ₁. The inductive element Lₗ₁ shown in FIG. 3 connects in series, for example, the inductive element Lₗ₁₁ and the inductive element Lₗ₁₂ shown in FIG. 2. Capacitive coupling occurs between the capacitive element Cₗ₁ and the capacitive element Cₕ₁, and inductive coupling occurs between the inductive element Lₗ₁ and the inductive element Lₕ₁. Magnitude of the coupling coefficient k between the first resonator 220 and the second resonator 230 is shown by the absolute value of a difference between an inductive coupling coefficient kₘ and a capacitive coupling coefficient kₑ, and the following formula (1) is given. That is, the inductive coupling and the capacitive coupling is cancelled each other.

|k|=|kₑ−kₘ| (1)

Next, the effect of the embodiment will be described.

FIG. 4 is a pattern diagram illustrating disposition of the resonators in the embodiment.

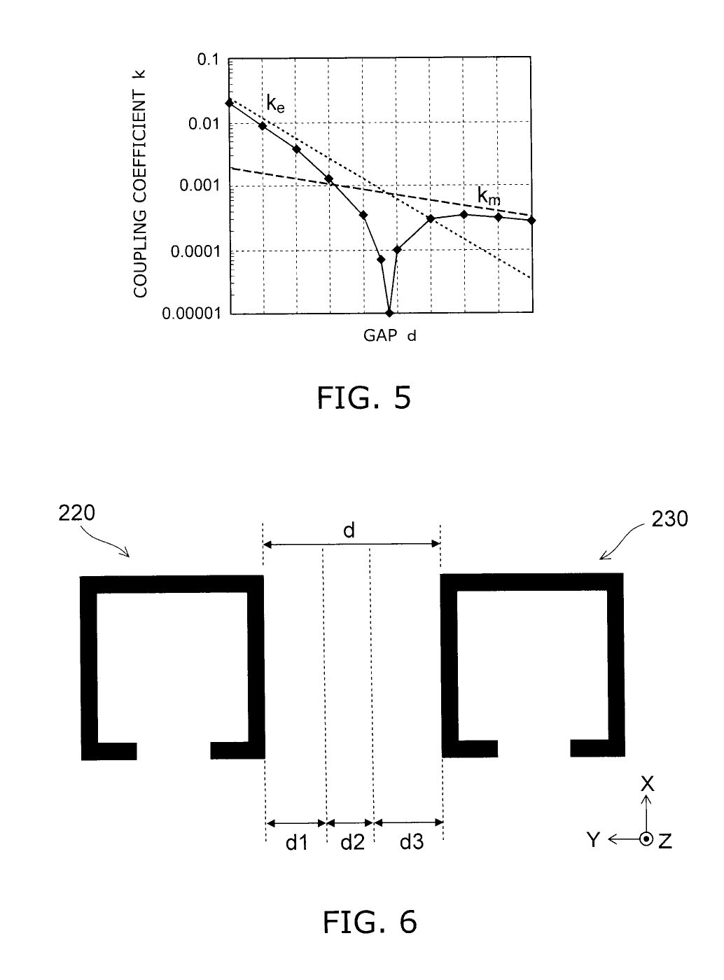

FIG. 5 illustrates a graph of a relationship between disposition of the resonators according to the embodiment and a coupling coefficient k by representing a gap d shown in FIG. 4 on a horizontal axis and representing the coupling coefficient k on a vertical axis.

FIG. 6 is a pattern diagram illustrating a range existing between the two resonators in the first embodiment with the gap d.

The first resonator 220 shown in FIG. 4, and FIG. 6 is a loop type resonator having an electric length of a half wavelength corresponding to the resonant frequency fₗ of the first passband. The second resonator 230 shown in FIG. 4, and FIG. 6 is a loop type resonator having an electric length of a half wavelength corresponding to the resonant frequency fₕ of the second passband. In a resonant state of the first resonator 220, electric field near a both ends open portion 218 is strengthened, and a capacitive component occurs at the both ends open portion 218. A current is concentrated to be large near a line center 219, and an inductance component (magnetic field) occurs near the line center 219. It is much the same for the second resonator 230. As a result, the capacitive coupling occurs between the both ends open portion 218 and a both ends open portion 228, and the inductive coupling occurs between the line center 219 and a line center 229.

As shown in FIG. 4, in the first resonator 220 and the second resonator 230 in the embodiment, a linear portion from a first inflection portion to the next inflection portion in the counterclockwise direction from an end of the both ends open portion 218 on the second resonator 230 side to the line center 219 and a linear portion from a first inflection portion to the next inflection portion in the clockwise direction from an end of the both ends open portion 228 on the first resonator 220 side to the line center 229 is disposed with a separation of a gap d.

In the case of this disposition, the capacitive coupling occurs between the both ends open portion 218 and the both ends open portion 228. The inductive coupling occurs between the line center 219 and the line center 229. There is no large difference between a distance from the both ends open portion 218 to the both ends open portion 228 and a distance from the line center 219 to the line center 229. Therefore, the coupling state is a mixed state of the capacitive coupling and the inductive coupling in the same degree.

As shown in FIG. 5, when the gap d is increased from 0, the capacitive coupling coefficient kₑ and the inductive coupling coefficient kₘ decrease monotonously. However, when the gap d is 0, a value of the capacitive coupling coefficient kₑ is higher than a value of the inductive coupling coefficient kₘ, and a decreasing ratio of the capacitive coupling coefficient kₑ to increase of the gap d is larger than a decreasing ratio of the inductive coupling coefficient kₘ, and thus in FIG. 5, a straight line showing the capacitive coupling coefficient kₑ and a straight line showing the inductive coupling coefficient kₘ intersects. The coupling coefficient k has the relationship of the above formula (1) between the capacitive coupling coefficient kₑ and the inductive coupling coefficient kₘ, and thus the capacitive coupling coefficient kₑ and the inductive coupling coefficient kₘ is cancelled each other and a minimum point of the coupling coefficient k exists.

That is, as shown in FIG. 6, in a range of the gap from 0 to d1, the capacitive coupling is dominant. In a range of the gap d from (d1+d2) to (d1+d2+d3), the inductive coupling is dominant. In a range of the gap d from (d1) to (d1+d2), the capacitive coupling coefficient kₑ and the inductive coupling coefficient kₘ is cancelled and a minimum point of the coupling coefficient k exists.

Then, in the multiband filter 1 according to the embodiment, the first resonator 220 and the second resonator 230 are disposed so that the coupling coefficient k is, for example, in a range of 10-3≧k, and thereby the coupling coefficient between both filter units can be reduced to improve the isolation characteristics outside the band.

Next, a first comparative example of the first embodiment will be described.

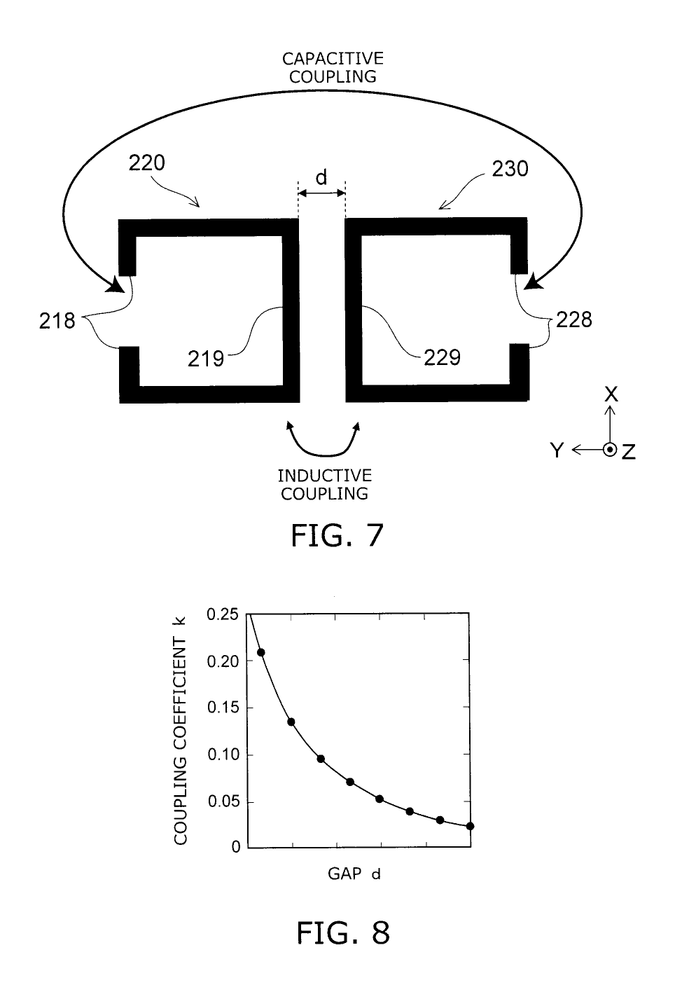

FIG. 7 is a pattern diagram illustrating disposition of resonators in the first comparative example of the embodiment.

FIG. 8 illustrates a graph of a relationship between disposition of the resonators and the coupling coefficient k by representing the gap d shown in FIG. 7 on a horizontal axis and representing the coupling coefficient k on a vertical axis.

As shown in FIG. 7, in a resonator in the first comparative example of the embodiment, the line center 219 of the first resonator 220 and the line center 229 of the second resonator 230 are disposed to oppose with separation of the gap d. In the case of this disposition, the line center 219 and the line center 229 with large current flowing are disposed near, and thus the inductive coupling is dominant. As shown in FIG. 8, the coupling coefficient k decreases monotonously with increase of the gap d between the first resonator 220 and the second resonator 230.

Next, a second comparative example of the first embodiment will be described.

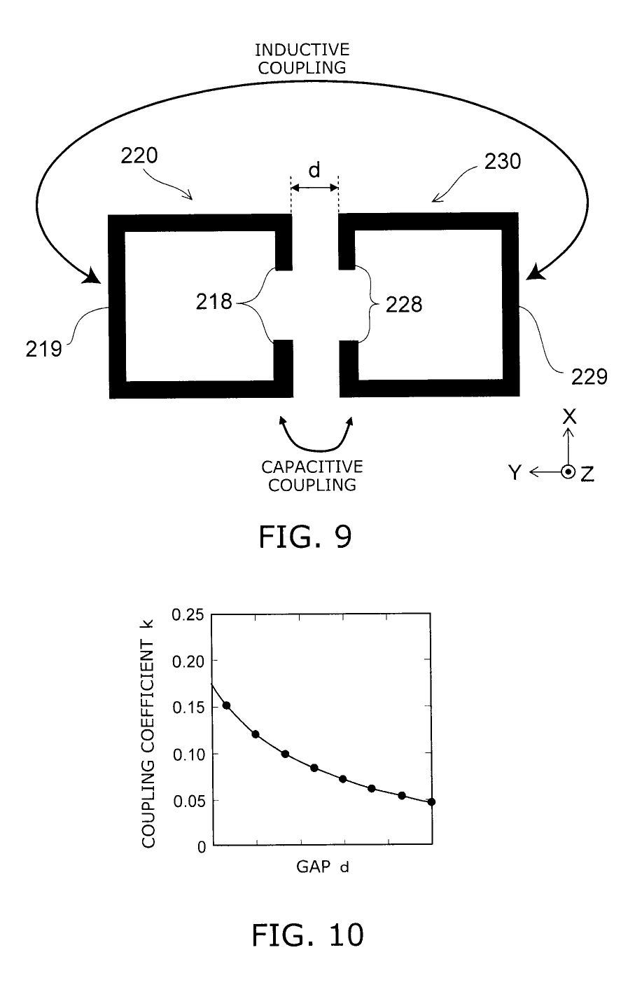

FIG. 9 is a pattern diagram illustrating disposition of the resonators in a second comparative example of the embodiment.

FIG. 10 illustrates a graph of a relationship between disposition of the resonators and the coupling coefficient k by representing the gap d shown in FIG. 9 on a horizontal axis and representing the coupling coefficient k on a vertical axis.

As shown in FIG. 9, in a resonator in the second comparative example of the embodiment, the both ends open portion 218 of the first resonator 220 and the both ends open portion 228 of the second resonator 230 are disposed to oppose with separation of the gap d. In the case of this disposition, the both ends open portion 218 and the both ends open portion 228 with intense electric field are disposed near, and thus the capacitive coupling is dominant. As shown in FIG. 10, the coupling coefficient k decreases monotonously with increase of the gap d.

In the multiband filter 1 according to the embodiment, for example, the configuration of one inflected microstrip line resonator is described as the first resonator 220 and the second resonator 230, however is not limited thereto. For example, a line structure may be a strip line and a co-planar line or the like. Various structures such as a hair-pin type, a concentrated constant type, a spiral type or the like may be adopted for a resonator structure.

Next, a second embodiment will be described.

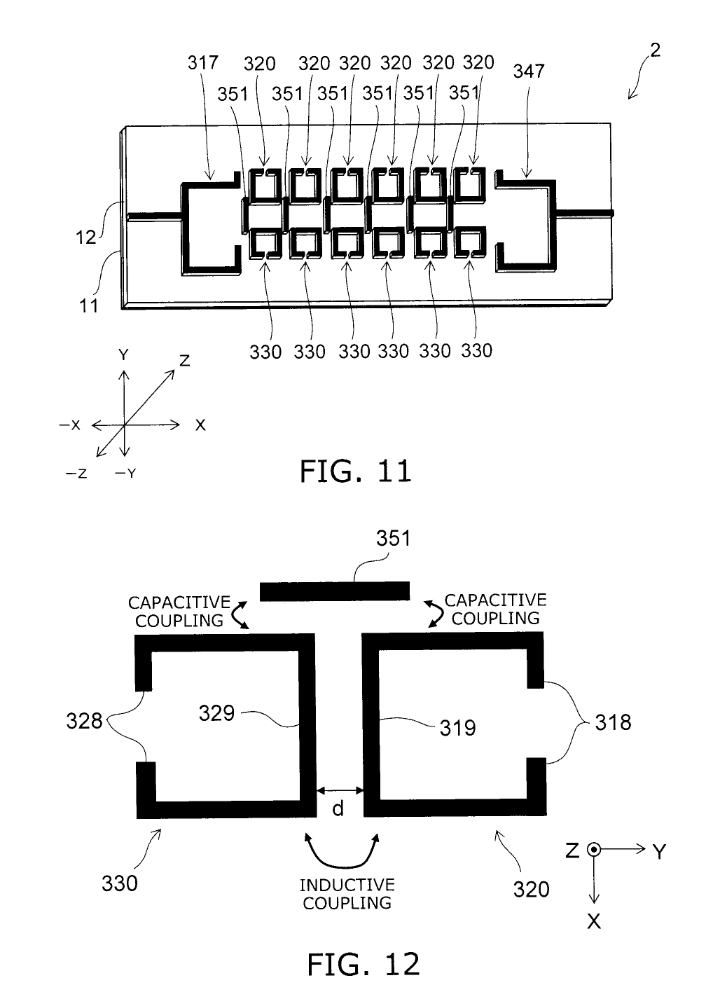

FIG. 11 is a perspective view illustrating a multiband filter according to the embodiment.

FIG. 12 is a pattern diagram illustrating disposition of the resonators in the embodiment.

As shown in FIG. 11 and FIG. 12, compared a multiband filter 2 according to the embodiment with the multiband filter 1 according to the first embodiment described above, first resonators 320 are provide in place of the first resonators 120 and the first resonators 125. Second resonators 330 are provided in place of the second resonators 130 and the second resonators 135. A coupling line 351 for the capacitive coupling is newly provided. A line center 319 of the first resonator 320 and a line center 329 of the second resonator 320 are disposed with separation of the gap d.

The first resonator 320 has the configuration of the first resonator 120 shown in FIG. 1 rotated by 90 degrees in the clockwise direction viewed in the Z-direction. The second resonator 330 has the configuration of the second resonator 130 shown in FIG. 1 rotated by 90 degrees in the counterclockwise direction viewed in the Z-direction. However, a length of a portion of the second resonator 130 in the X-direction is different from a length of a portion of the second resonator 130 shown in FIG. 1 in the X-direction. A length of a portion of the second resonator 130 in the Y-direction is different from a length of a portion of the second resonator 130 shown in FIG. 1 in the Y-direction.

The configurations of coupling lines 351 are linear and extend in the X-direction. Ends of the coupling lines 351 in the Y-direction are disposed between portions of the adjacent first resonators 320 in the −Y-direction and between a division multiplexing unit 317 and a portion of the first resonator 320 disposed closest to the division multiplexing unit 317 in the −Y-direction. On the other hand, ends of the coupling lines 351 in the −Y-direction are disposed between portions of the adjacent first resonators 330 in the Y-direction and between a division multiplexing unit 317 and a portion of the first resonator 330 disposed closest to the division multiplexing unit 317 in the Y-direction.

The configuration other than the above in the embodiment is similar to the first embodiment described above.

Next, an operation and effect of the multiband filter 2 according to the embodiment will be described.

In the multiband filter 2 according to the embodiment, the line center 319 and the line center 329 with large current flowing are separated by the gap d. A both ends open portion 318 and a both ends open portion 328 with intense electric field are separated by more than the gap d. Therefore, the inductive coupling is larger than the capacitive coupling and the inductive coupling is dominant.

Then, in order to cancel this inductive coupling, as described above, the coupling line 351 is disposed near the first resonator 320 and the second resonator 330. This produces new capacitive coupling between the coupling line 351 and the first resonator 320. This produces new capacitive coupling between the coupling line 351 and the second resonator 330 as well. These newly produced capacitive couplings can be cancelled the inductive coupling to reduce the coupling coefficient between two resonators, and thus the isolation characteristics can be improved.

In the embodiment, it is only necessary to provide the coupling line 351 newly in order to cancel the inductive coupling, and thus it can be also applied to the case where downsizing makes a space between resonators extremely narrow.

The operation and effect other than the above in the embodiment are the same as the first embodiment described above.

Next, a third embodiment will be described.

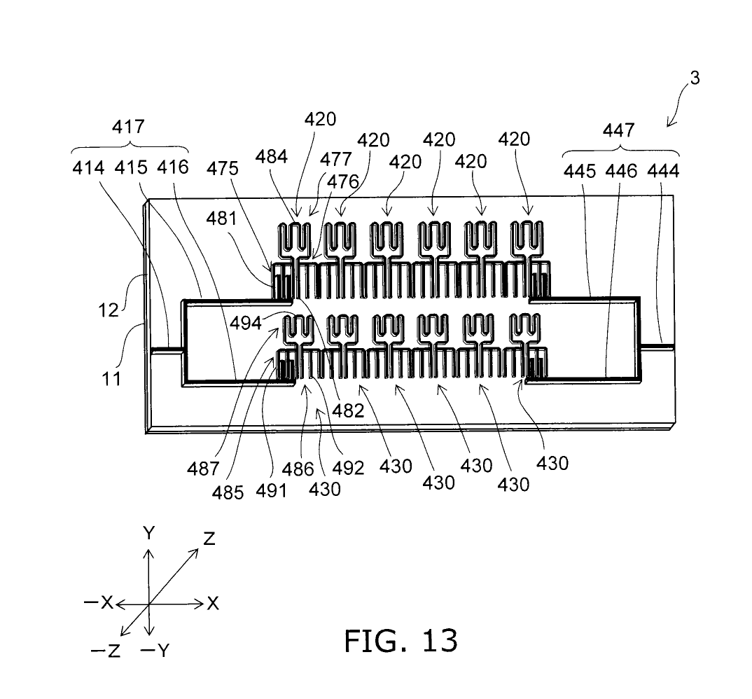

FIG. 13 is a perspective view illustrating a multiband filter according to the embodiment.

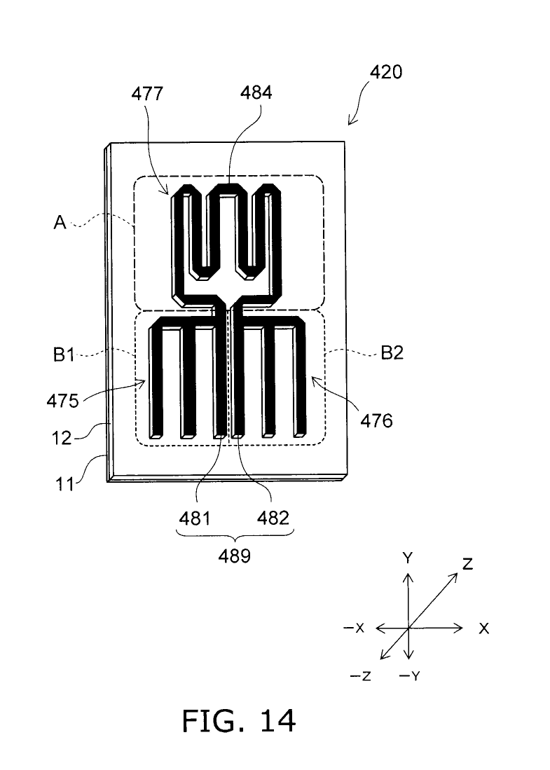

FIG. 14 is a perspective view illustrating a resonator in the embodiment.

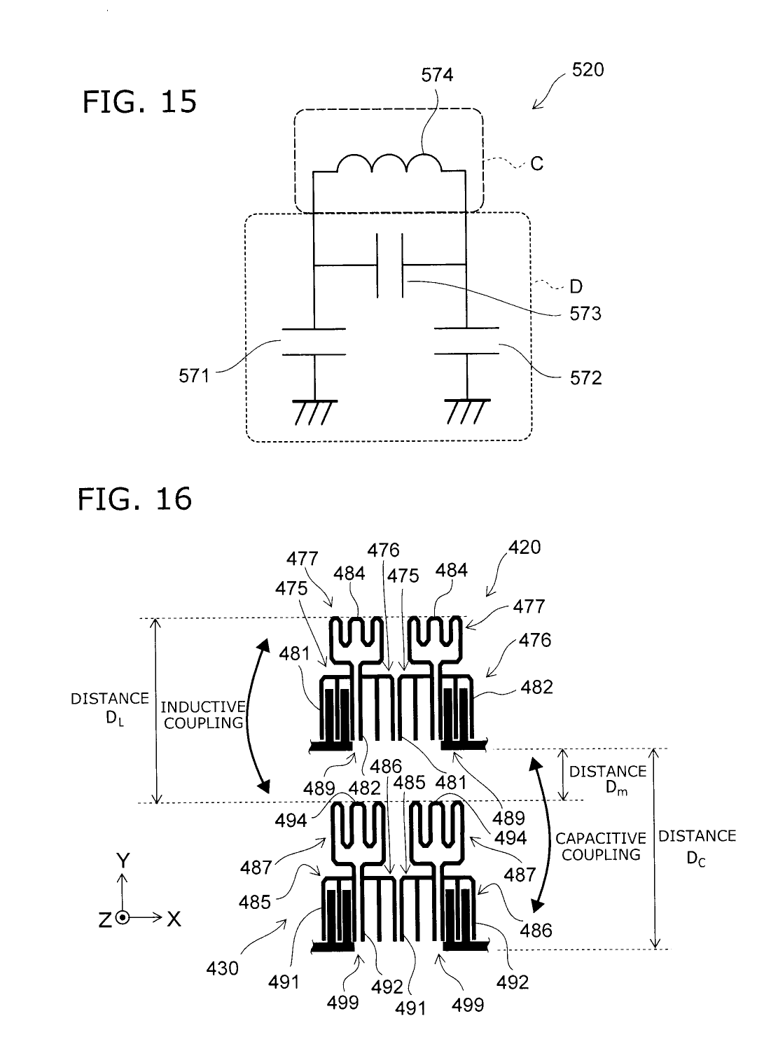

FIG. 15 is an equivalent diagram illustrating the resonator in the embodiment.

FIG. 16 is a pattern diagram illustrating disposition of the resonators in the embodiment.

As shown in FIG. 13, compared a multiband filter 3 according to the embodiment with the multiband filter 1 according to the first embodiment described above, a division multiplexing unit 417 is provided in place of the division multiplexing unit 117. A division multiplexing unit 447 is provided in place of the division multiplexing unit 147. First resonators 420 are provided in place of the first resonators 120 and the first resonators 125. Second resonators 430 are provided in place of the second resonators 130 and the second resonators 135.

In the division multiplexing unit 417, an input/output portion 414 in an interconnect configuration extending in the X-direction branches into branches 415 and 416 at one end, and the branches 415 and 416 are disposed distantly in the Y-direction. The branch 415 is extracted from the one end of the input/output portion 414, is inflected beyond to extend in the X-direction, and branches beyond. One of branches is inflected to extend in the Y-direction and terminate, and another one of branches extends in the X-direction, and is inflected beyond to extend in the Y-direction and terminate. The branch 416 is extracted in the −Y-direction from the one end of the input/output portion 414 where the branch 415 is extracted, is inflected beyond to extend in the X-direction, and branches beyond. One of branches is inflected to extend in the Y-direction and terminate, and another one of branches extends in the X-direction, and is inflected beyond to extend in the Y-direction and terminate.

A termination of the branch 415 and a termination of the branch 416 extend in the same direction, however the lengths are different, and the termination of the branch 416 is shorter than the termination of the branch 415. The branch 415 has two terminations, and has the same length. The branch 416 has two terminations, and has the same length.

The first resonator 420 has the configuration that one end of a meander form portion 477 is connected to an inflection portion of a comb form portion 475 closest to one of ends of the comb form portion 475 in the X-direction, the one being adjacent to a comb form portion 476, and has the configuration that another end of the meander form portion 477 is connected to an inflection portion of the comb form portion 476 closest to one of ends of the comb form portion 476 in the −X direction, the one being adjacent to the comb form portion 475. The respective resonators 420 are disposed so that the meander form portion 477 is in the Y-direction viewed from the comb form portion 475.

The second resonator 430 has the configuration that one end of a meander portion 487 is connected to an inflection portion of a comb form portion 485 closest to one of ends of the comb form portion 485 in the X-direction, the one being adjacent to a comb form portion 486, and has the configuration that another end of the meander form portion 487 is connected to an inflection portion of the comb form portion 486 closest to one of ends of the comb form portion 486 in the −X-direction, the one being adjacent to the comb form portion 485. A line length of the meander form portion 487 is shorter than a line length of the meander form portion 477. A length of a line of the comb form portion 485 extending in the Y-direction is shorter than a length of a line of the comb form portion 475 extending in the Y-direction. The respective second resonators 430 are disposed in the same direction as the first resonators 420. A configuration of the division multiplexing unit 447 forms a mirror image of the division multiplexing unit 417 about the YZ-plane.

Between lines located at first and second from a side in the −X-direction of the comb form portion of the first resonator 420, one of ends of the branch 415 is inserted. Between lines located at third and fourth from a side in the −X direction of the comb form portion of the first resonator 420, another one of ends of the branch 415 is inserted.

The ends of the comb form portion 475 in a section B1 shown in FIG. 14 are taken as open portions 481. Because the open portions 481 are open, the electric field is intense around there, and capacitance occurs between the open portions and the ground conductor plate 11. This occurred capacitance is shown as a capacitive element 571 in the equivalent circuit of FIG. 15. Similarly, the electric field is intense around the open portions 482 of the comb form portion 476 in a section B2 shown in FIG. 14, and capacitance occurs between the open portion and the ground conductor plate 11. This is shown as a capacitive element 572 in the equivalent circuit of FIG. 15. Capacitance also occurs between the comb form portion 475 and the comb form portion 476 shown in FIG. 14, and this is shown as a capacitive element 573 in the equivalent circuit of FIG. 15. The open portions 481 and the open portions 482 are taken as open portions 489 collectively. The open portions 491 and the open portions 492 are taken as open portions 499 collectively.

A middle point of the line length of the meander form portion 477 in a section A shown in FIG. 14 is taken as a line center 484. A current is increased around the line center, and a magnetic field occurs around the line center 484. This is shown as an inductive element 574 in the equivalent circuit of FIG. 15. As shown in FIG. 15, the first resonator 520 of the multiband filter 3 according to the embodiment operates as a half wavelength resonator because of including the inductive element 574, the capacitive element 571, and the capacitive element 572.

The first resonator 420 shown in FIG. 14 can be more capacitive by increasing areas of the comb form portion 475 and the comb form portion 476. The first resonator 420 shown in FIG. 14 can be more inductive by making the line length of the meander form portion 477 long, or making a line width narrow.

The configuration other than the above of the embodiment is the same as the first embodiment described above.

Next, the effect of the multiband filter 3 according to the embodiment will be described.

As shown in FIG. 13 and FIG. 16, in the multiband filter 3 according to the embodiment, the first resonators 420 and the second resonators 430 are disposed as described below.

A distance between the open portion 489 of the first resonator 420 where the electric field is intense and the capacitance occurs and the open portion 499 of the second resonator 430 where the electric field is intense and the capacitance occurs is taken as a distance D_{C}. A distance between the line center 484 of the first resonator 420 where the large current flows and the magnetic field occurs and the line center 494 of the second resonator 430 where the large current flows and the magnetic field occurs is taken as a distance D_{L}. A distance between the first resonator 420 and the second resonator 430 is taken as a distance Dₘ. Here, the first resonator 420 and the second resonator 430 are disposed at positions where the formula (2) and the formula (3) described below hold.

D_{C}>Dₘ (2)

D_{L}>Dₘ (3)

In the case of the disposition described above, the capacitive coupling occurs between the open portion 489 and the open portion 499. The inductive coupling occurs between the line center 484 and the line center 494. The distance D_{C} between the open portion 489 and the open portion 499 is not greatly different from the distance D_{L} between the line center 484 and the line center 494. Therefore, the capacitive coupling is mixed with the inductive coupling. The coupling coefficient of these couplings has the relationship of the formula (1) described above, the capacitive coupling is cancelled the inductive coupling, and the coupling coefficient can be reduced.

A distance between the open portion 489 and the line center 494 is taken as a distance D_{CL} and a distance between the line center 484 and the open portion 499 is taken as a distance D_{LC}, and then at least one on the distance D_{CL} and a distance D_{LC} may be shorter than the distance D_{C} and the distance D_{L}.

Next, a first comparative example of the third embodiment will be described.

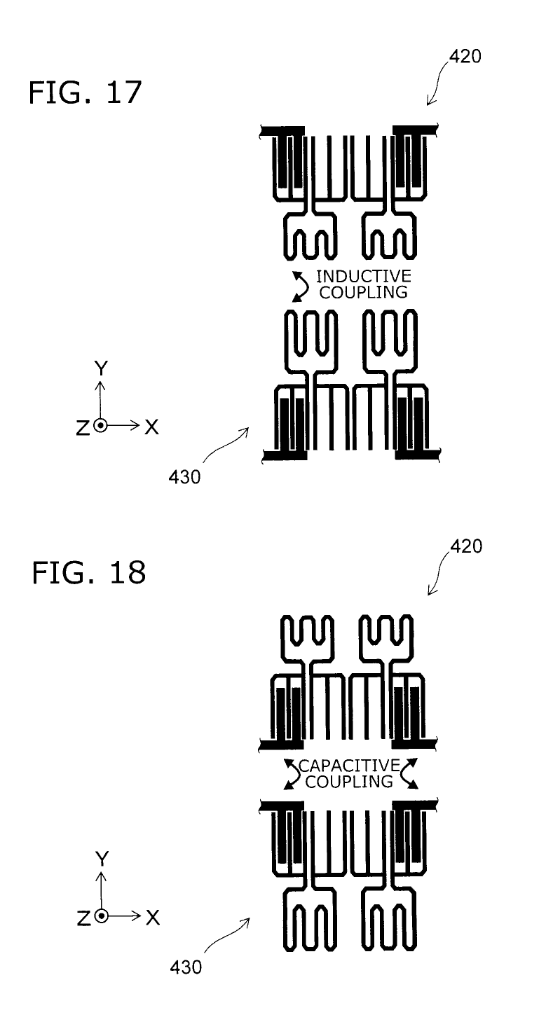

FIG. 17 is a pattern diagram illustrating disposition of resonators in a first comparative example of the embodiment.

Compared FIG. 17 with FIG. 16, the first resonator 420 is rotated by 180 degrees viewed in the Z-direction. In the case of this disposition, the distance between the open portion 489 and the open portion 499 where the capacitance occurs becomes larger than the distance between the line center 484 and the line center 494 where the magnetic field occurs. As a result, the inductive coupling is dominant. Thereby, the coupling between the first resonator 420 and the second resonator 430 becomes extremely intense.

Next, a second comparative example of the third embodiment will be described.

FIG. 18 is a pattern diagram illustrating disposition of resonators in a second comparative example of the embodiment.

Compared FIG. 18 with FIG. 16, the second resonator 430 is rotated by 180 degrees viewed in the Z-direction. In the case of this disposition, the distance between the open portion 489 and the open portion 499 where the capacitance occurs becomes smaller than the distance between the line center 484 and the line center 494 where the magnetic field occurs. As a result, the capacitive coupling is dominant. Thereby, the coupling between the first resonator 420 and the second resonator 430 becomes extremely intense.

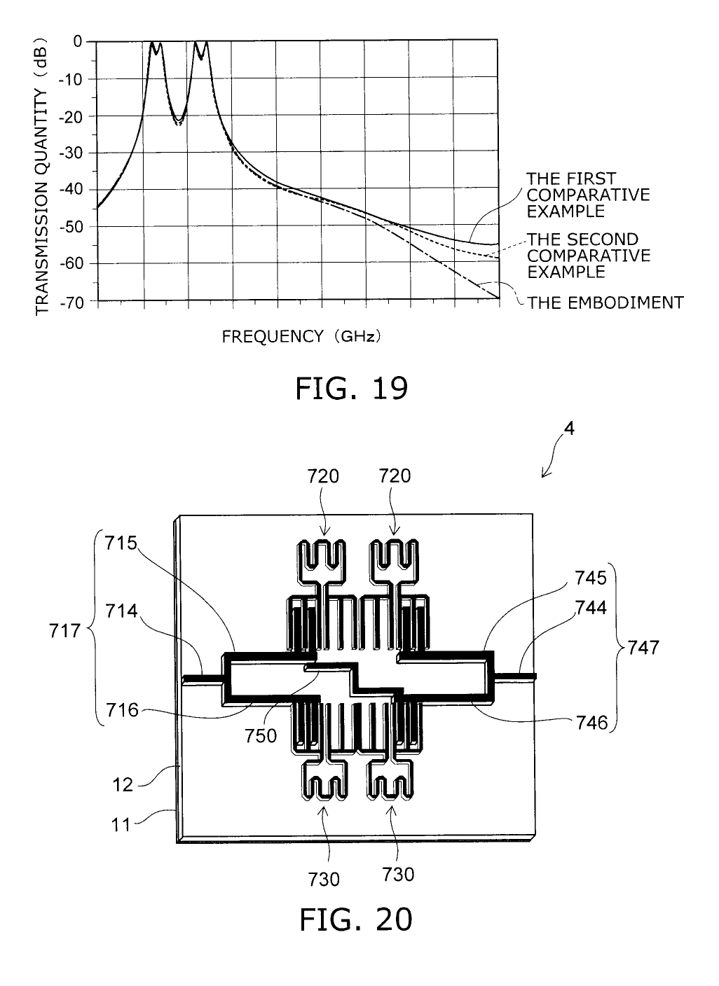

FIG. 19 illustrates a graph diagram of frequency characteristics of a multiband filter according to the embodiment by representing a frequency on a horizontal axis and representing transmission quantity on a vertical axis.

As shown in FIG. 19, compared the first comparative example with the second comparative example, isolation outside the band of the multiband filter 3 according to the embodiment is improved by more than about 10 dB at a desired frequency.

As described above, induction property or capacitive property can be easily intensified by using the first resonator 420 shown in FIG. 14. As a result, the coupling coefficient between the resonators can be controlled and the coupling coefficient can be small.

Next, a fourth embodiment will be described.

FIG. 20 is a perspective view illustrating a multiband filter according to the embodiment.

As shown in FIG. 20, a multiband filter 4 according to the embodiment is different from the multiband filter 3 according to the third embodiment in the following points (a) to (d).

(a) The number of a first resonator 720 and a second resonator 730 is 2, respectively.
(b) In the pattern diagram of the second resonator 730, the second resonator 430 in the third embodiment described above shown in FIG. 13 is rotated by 180 degrees in the clockwise direction viewed in the Z-direction.
(c) Along with the above (b), a termination of a branch 716 and a termination of a branch 746 extend in the (−Y)-direction.
(d) A coupling line 750 is provided.

One end of the coupling line 750 is provided spaced from a branch 715 in the vicinity of an inflection portion beyond of the branch 715 extending in the X-direction, and one other end is provided spaced from the branch 746 in the vicinity of an inflection portion beyond of the branch 746 extending in the (−X)-direction. The coupling line 750 is extracted from the one end in the X-direction, is inflected beyond to extend in the (−Y)-direction, and is inflected again beyond to extend in the X-direction and is terminated.

The configuration other than the above of the embodiment is the same as the third embodiment described above.

A current flows through the branch 715 of a division multiplexing unit 717, and a magnetic field occurs around there. A current also flows through the branch 746 of a division multiplexing unit 747, and a magnetic field occurs around there. Here, for example, in the case where the number of the first resonator 720 and the second resonator 730 of the multiband filter 4 is taken as 2 for downsizing, respectively, the branch 715 of the division multiplexing unit 717 and the branch 746 of the division multiplexing unit 747 are disposed near. As a result, the magnetic field which occurred around the branch 715 comes around the branch 746 and the inductive coupling occurs.

In this case, as shown in FIG. 20, the coupling line 750 is disposed to be in the vicinity of the branch 715 and the branch 746. Thereby, the capacitive coupling occurs between the one end of the coupling line 750 and the branch 715. The capacitive coupling also occurs between the one other end of the coupling line 750 and the branch 746. As a result, the inductive coupling occurred between the branch 715 and the branch 746 is cancelled and the isolation characteristics outside the band can be improved.

Next, a variation of the fourth embodiment will be described.

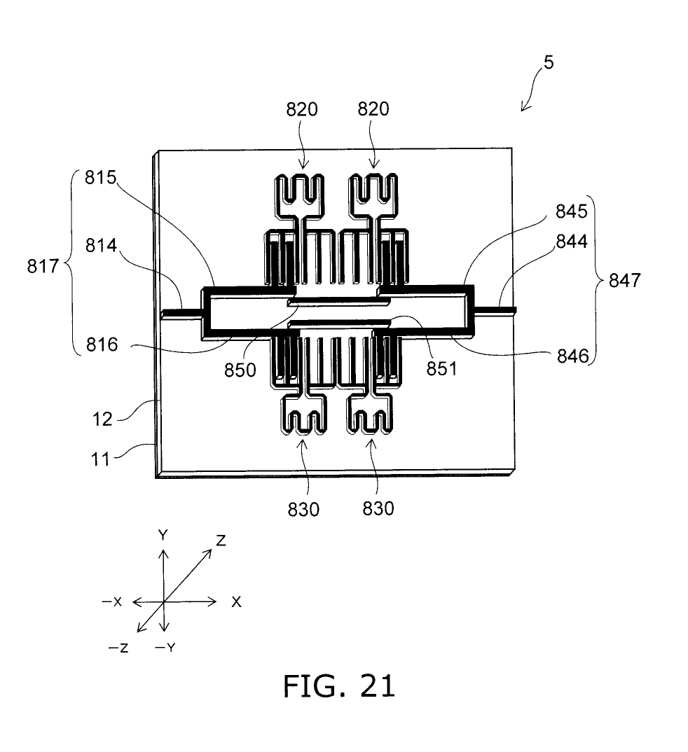

FIG. 21 is a perspective view illustrating a multiband filter according to the variation.

As shown in FIG. 21, the multiband filter 5 according to the variation is different from the multiband filter 4 according to the fourth embodiment described above in a point of coupling lines 850 and 851 being provided in place of the coupling line 750.

The configurations of the coupling lines 850 and 851 are linear and extend in the X-direction, respectively. An end of the coupling line 850 on a side in the −X-direction is provided spaced from a branch 815 in the vicinity of an inflection portion beyond of the branch 815 extending in the X-direction, an end on a side in the X-direction is provided spaced from a branch 845 in the vicinity of an inflection beyond of the branch 845 extending in the −X-direction. An end of the coupling line 851 on a side in the −X-direction is provided spaced from the branch 816 in the vicinity of an inflection portion beyond of the branch 816 extending in the X-direction, an end on a side in the X-direction is provided spaced from a branch 846 in the vicinity of an inflection beyond of the branch 846 extending in the −X-direction.

The configuration other than the above of the variation is the same as the fourth embodiment described above.

A current flows through the branch 815 of a division multiplexing unit 817, and a magnetic field occurs around there. A current also flows through the branch 845 of a division multiplexing unit 847, and a magnetic field occurs around there. Here, in the case where the number of the first resonator 820 and the second resonator 830 of the multiband filter 5 is taken as 2 for downsizing, respectively, the branch 815 of the division multiplexing unit 817 and the branch 845 of the division multiplexing unit 847 are disposed near. As a result, the magnetic field which occurred around the branch 815 comes around the branch 845 and the inductive coupling occurs.

In this case, as shown in FIG. 21, the coupling line 850 is disposed to be in the vicinity of the branch 815 and the branch 845. Thereby, the capacitive coupling occurs between the one end of the coupling line 850 and the branch 815. The capacitive coupling also occurs between the one other end of the coupling line 850 and the branch 845. As a result, the inductive coupling occurred between the branch 815 and the branch 845 is cancelled and the isolation characteristics outside the band can be improved.

The same reason holds true with the coupling line 851. The inductive coupling which occurred between the branch 816 and the branch 846 is cancelled and the isolation characteristics outside the band can be improved.

According to the plurality of embodiments described above, even if a plurality of filters are multiplexed closely, multiband filters having the isolation characteristics outside the band improved can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A multiband filter comprising:
a first resonator having a first capacitive component and a first inductive component, a signal of a first frequency being inputted to the first resonator; and
a second resonator having a second capacitive component and a second inductive component, a signal of a second frequency being inputted to the second resonator and the second frequency being different from the first frequency,
a distance between a first capacitive component of the first resonator and a second capacitive component of the second resonator and a distance between a first inductive component of the first resonator and a second inductive component of the second resonator being longer than a shortest distance out of a distance between the first resonator and the second resonator, the first capacitive component occurring at the first capacitance, the second capacitive component occurring at the second capacitance, the first inductive component occurring at the first inductance, the second inductive component occurring at the second inductance.

2. The filter according to claim 1, wherein
at least one of a distance between the first capacitive component and the second inductive component and a distance between the second capacitive component and the first inductive component is shorter than the distance between the first capacitive component and the second capacitive component and the distance between the first inductive component and the second inductive component.

3. The filter according to claim 1, wherein
when a coupling degree between the first capacitive component and the second capacitive component is taken as a capacitive coupling coefficient,
a coupling degree between the first inductive component and the second inductive component is taken as an inductive coupling coefficient,
an absolute value of a difference between the capacitive coupling coefficient and the inductive coupling coefficient is taken as a coupling coefficient,
the distance between the first resonator and the second resonator is taken as a first distance at which the coupling coefficient is equal to the inductive coupling coefficient, and
the distance between the first resonator and the second resonator is taken as a second distance at which the coupling coefficient is equal to the capacitive coupling coefficient,
the distance between the first resonator and the second resonator has a value of a distance between the first distance and the second distance.

4. The filter according to claim 3, wherein
the distance between the first resonator and the second resonator is a distance at which the coupling coefficient is minimum.

5. The filter according to claim 1, wherein
the first capacitive component includes a portion at which electric field in the first resonator is maximum,
the first inductive component includes a portion at which a current in the first resonator is maximum,
the second capacitive component includes a portion at which electric field in the second resonator is maximum, and
the second inductive component includes a portion at which a current in the second resonator is maximum.

6. The filter according to claim 1, wherein
configurations of the first resonator and the second resonator are frame-shaped being lack of a center of one side,
the lack portion forms a both ends portion,
a portion opposing the both ends portion forms a center portion,
the first capacitive component includes the both ends portion of the first resonator,
the first inductive component includes the center portion of the first resonator,
the second capacitive component includes the both ends portion of the second resonator, and
the second inductive component includes the center portion of the second resonator.

7. The filter according to claim 1, further comprising:
a coupling line disposed between the first resonator and the second resonator.

8. A multiband filter comprising:
a first resonator having a first capacitive component and a first inductive component, a signal of a first frequency being inputted to the first resonator;
a second resonator having a second capacitive component and a second inductive component, a signal of a second frequency different from the first frequency; and
a coupling line disposed between the first resonator and the second resonator,
a distance between a first inductive component of the first resonator and a second inductive component of the second resonator being shorter than a distance between a first capacitive component of the first resonator and a second capacitive component of the second resonator, a distance between the first inductive component and the second capacitive component, and a distance between the first capacitive component and the second inductive component, the first inductive component occurring at the first inductance, the second inductive component occurring at the second inductance, the first capacitive component occurring at the first capacitance, the second capacitive component occurring at the second capacitance.

9. The filter according to claim 7, wherein
the coupling line includes a metal, a superconductor, or a Y-based copper oxide high temperature superconducting material.

10. The filter according to claim 1, wherein
the first resonator and the second resonator include a metal, a superconductor, or a Y-based copper oxide high temperature superconducting material.

11. The filter according to claim 1, wherein
the first resonator, the second resonator, and the coupling line are formed of a microstrip line resonator, a strip line, or a coplanar line.

12. The filter according to claim 1, wherein
a length of the second inductive component is shorter than a length of the first inductive component.

13. The filter according to claim 1, wherein
when a center frequency of the first frequency is taken as a first center frequency, and
a frequency band width of the first frequency is taken as a first frequency band width,
a frequency subtracting a half of the frequency band width of the first frequency band width from the first center frequency is a first lower limit frequency,
a frequency adding the half of the frequency band width of the first frequency band width to the first center frequency is a first upper limit frequency, and
an electrical length from one end of the first resonator to one other end is an electrical length from an integral multiple of a half of a wavelength corresponding to the first lower limit frequency to an integral multiple of a wavelength corresponding to the first upper limit frequency.

14. The filter according to claim 10, wherein
the metal includes copper or gold.

15. The filter according to claim 10, wherein
the superconductor includes niobium or niobium tin.

16. The filter according to claim 1, wherein
the first resonator and the second resonator include
a first comb form portion including
a plurality of first lines extending in a first direction and mutually isolated in a second direction different from the first direction, and
a second line extending in the second direction and connected to an end portion of each of the first lines in the first direction,
a second comb form portion including
a plurality of third lines extending in the first direction and mutually isolated in the second direction, and
a fourth line extending in the second direction and connected to an end portion of each of the third lines in the first direction,
a meander form portion including one end portion connected to the second line and one other end portion connected to the fourth line, the one end portion being a first portion, the one other end portion being a second portion,
one of the first lines closest to the third lines and one of the third lines closest to the first lines form an open portion,
a portion of the meander form portion having a length from the first portion being equal to a length from the second portion forms a center portion,
the first capacitive component includes the open portion of the first resonator,
the first inductive component includes the center portion of the first resonator,
the second capacitive component includes the open portion of the second resonator, and
the second inductive component includes the center portion of the second resonator.

17. The filter according to claim 16, wherein
a line length of the meander form portion of the first resonator is shorter than a line length of the meander form portion of the second resonator, and
a line length of the first lines of the second resonator is shorter than a line length of the first lines of the first resonator.

18. The filter according to claim 16, further comprising:
a first division multiplexing unit including
a first branch coupled with the first comb form portion of the first resonator by capacitive coupling, and
a second branch coupled with the first comb form portion of the second resonator by capacitive coupling;
a second division multiplexing unit including
a third branch coupled with the second comb form portion of the first resonator by capacitive coupling, and
a fourth branch coupled with the second comb form portion of the second resonator by capacitive coupling; and
a first coupling line including one end portion coupled with the first branch by capacitive coupling and including one other end portion coupled with the fourth branch by capacitive coupling.

19. The filter according to claim 18, further comprising:
a second coupling line including one end portion coupled with the first branch by capacitive coupling and including one other end portion coupled with the second branch by capacitive coupling.
